(19) United States
(12) Patent Application Publication
(10) Pub. No.: US 2006/0056408 A1
(43) Pub. Date: Mar. 16, 2006

(54) Method and device for universal plug and play communications

(75) Inventor: Jung-yon Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/199,998

(22) Filed: Aug. 10, 2005

(30) Foreign Application Priority Data
Aug. 28, 2004 (KR) 10-2004-0068256

(51) Int. Cl. H04L 12/56

(52) U.S. Cl. 370/389

(57) ABSTRACT

A method and a device for universal plug and play communications, wherein the method includes checking for a change in the presence of a dynamic host configuration protocol (DHCP) server in a network to which the communication device belongs, changing an Internet protocol address used by the communication device into an Internet protocol address allocated appropriately for the changed environment if it is determined as a result of the checking that a change has occurred in the presence of the DHCP server, and notifying another communication device of the changed Internet protocol address.

### CROSS-REFERENCE TO RELATED APPLICATION

This application claims priority from Korean Patent Application No. 10-2004-0068256 filed on Aug. 28, 2004, the disclosure of which is incorporated herein in its entirety by reference.

### BACKGROUND OF THE INVENTION

1. Field of the Invention

Devices, systems and methods consistent with the present invention relate to universal plug and play communications, and more particularly, to universal plug and play communications through prompt response to a change in an Internet protocol (IP) address, to thereby reduce the interruption time of communications.

2. Description of the Related Art

Generally, a home network is used to control various types of devices including a personal computer (PC), intelligent products, wireless devices, etc. by interconnecting them into a single network through a virtual computing environment called middleware.

Middleware connects various digital devices in a peer-to-peer manner, thereby enabling communications between devices. This kind of middleware employs home audio/video interoperability (HAVI), universal plug and play (UPnP), Java intelligent network infrastructure (JINI), home wide web (HWW), etc.

A UPnP communication device constituting a UPnP network consists of a controlled device to be controlled and a control point to control the controlled device. The controlled device and the control point conduct communications based on the IP.

IP addresses necessary for communications between the UPnP communication devices are allocated in two methods. An IP address allocating method is determined depending upon whether a dynamic host configuration protocol (DHCP) server exists within the network.

If a DHCP server is connected to the network, the UPnP communication devices are allocated IP addresses by the DHCP server. However, if no DHCP server exists over the network, the UPnP communication devices use IP addresses selected by an automatic IP allocating function (Auto IP). In this case, each UPnP communication device selects an IP addresses for its own use in an arbitrary manner within the auto IP allocating range (e.g., 169.254.0.1˜169.254.254.255). A UPnP communication device having selected an IP address ascertains whether the selected IP address is in use by another UPnP communication devices and then determines whether to use the IP address selected for its own use.

By the way, each UPnP communication device regularly checks whether a DHCP server exists within the network. While the UPnP communication devices constituting the home network are allocated IP addresses by the DHCP server and are using them, their connection to the DHCP server may be released within the home network. In this case, where the UPnP communication devices sense this disconnection, they establish new IP addresses to be used by them with the use of the Auto IP allocating function. Likewise, while the UPnP communication devices constituting the home network are using IP addresses established by the Auto IP allocating function, the DHCP server may be connected to the home network. In this case, if the UPnP communication devices sense this connection, they request IP addresses to be allocated by the DHCP server. According to this request, they establish the IP addresses allocated by the DHCP server as new IP addresses for their own use, and then use them.

As described above, the UPnP communication devices regularly check the presence of the DHCP server within a network to which they belong, and when a change in the presence of the DHCP server has occurred, they use new IP addresses appropriate for the changed environment.

According to this conventional art, IP addresses to indicate different subnets may exist in the same network while the UPnP communication devices having sensed a change in the presence of the DHCP server change the IP addresses according to the changed environment. In this case, the communications between the UPnP communication devices may be interrupted, and this interruption of communications may be continued until all of the UPnP communication devices constituting the same network sense the change in the presence of the DHCP server and are allocated new IP addresses according to the changed environment. Accordingly, the interruption of communications may continue as long as the UPnP communication devices ascertain the presence of the DHCP server, thereby causing inconvenience to the user.

### SUMMARY OF THE INVENTION

According to the present invention, the interruption time of communications due to a change in IP addresses may be reduced by allowing a UPnP communication device having first sensed a change in the presence of a DHCP server over the network, to transmit information associated with such a change to the other UPnP communication devices.

According to an aspect of the present invention, there is provided a method for universal plug and play communications, which is performed by a communication device, the method comprising: checking for a change in the presence of a DHCP server in a network to which the communication device belongs; changing an Internet protocol address used by the communication device into an Internet protocol address allocated appropriately for the changed environment if it is determined as a result of the checking that the change has occurred in the presence of the DHCP server; and notifying another communication device of the changed Internet protocol address.

According to an aspect of the present invention, there is provided a device for universal plug and play communications, the device comprising: a transceiving unit which transmits data to and receives data from another communication device; an address setting unit which changes an Internet protocol address used by the device into an Internet protocol address allocated appropriately for a changed environment if it is determined that a change has occurred in a presence of a DHCP server in a network connected to the device through the transceiving unit; and a control unit which checks for the presence of the DHCP server and transmits the changed Internet protocol address to the other communication device through the transceiving unit.

### BRIEF DESCRIPTION OF THE DRAWINGS

The above and/or other aspects of the present invention will become more apparent by describing in detail exemplary embodiments thereof with reference to the attached drawings in which:

FIG. 1 illustrates a network composed of UPnP communication devices according to an exemplary embodiment of the present invention;

FIG. 2 is a flow chart illustrating an operation for UPnP communications according to an exemplary embodiment of the present invention;

FIG. 3A illustrates a construction of an Advertisement packet according to an exemplary embodiment of the present invention;

FIG. 3B illustrates a construction of a Search packet according to an exemplary embodiment of the present invention;

FIG. 4 is a flow chart illustrating an operation for UPnP communications according to another exemplary embodiment of the present invention;

FIG. 5 is a flow chart illustrating an operation for UPnP communications according to another exemplary embodiment of the present invention;

FIG. 6 is a flow chart illustrating an operation for UPnP communications according to another exemplary embodiment of the present invention; and

FIG. 7 is a block diagram illustrating a UPnP communication device according to an exemplary embodiment of the present invention.

### DETAILED DESCRIPTION OF EXEMPLARY EMBODIMENTS OF THE INVENTION

The present invention and methods of accomplishing the same may be understood more readily by reference to the following detailed description of exemplary embodiments to be described in detail and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Hereinbelow, exemplary embodiments of the present invention will be described in detail with reference to the accompanying drawings.

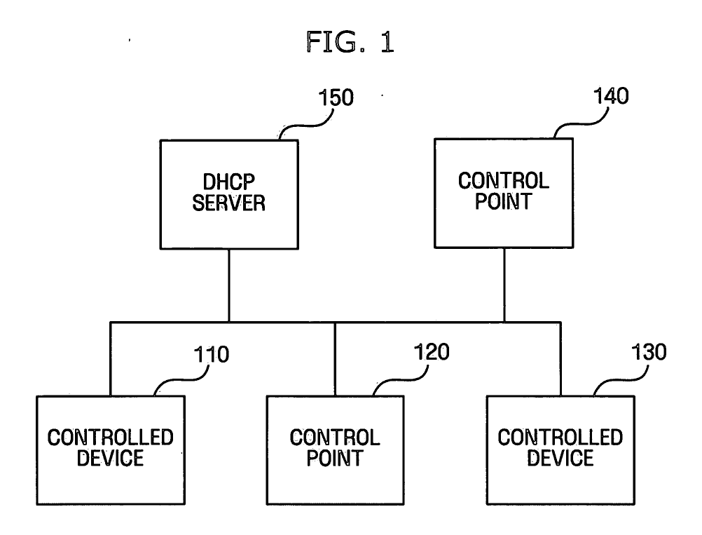

In FIG. 1, a network composed of UPnP communication devices according to an exemplary embodiment of the present invention is illustrated.

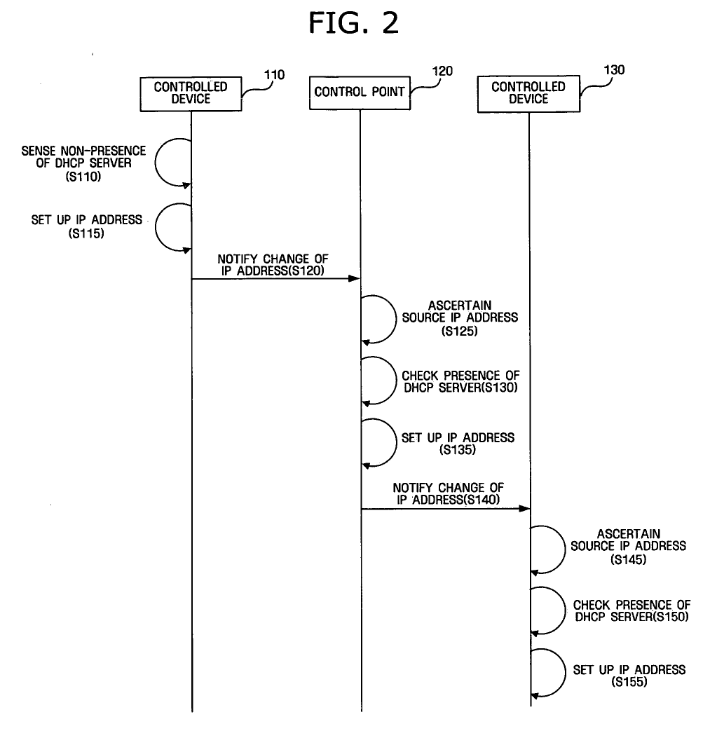

As illustrated, the network comprises controlled devices 110 and 130, control points 120 and 140 which control the controlled devices 110 and 130, and a DHCP server 150 which allocates IP addresses to the UPnP communication devices 110 to 140. In describing this exemplary embodiment, four states may be roughly caused in the network. Each state will be described with reference to FIGS. 2 to 6.

A first state in which a controlled device first senses that a DHCP server is disconnected from the network will be described with reference to FIG. 2.

In this exemplary embodiment, description of the control point 140 will be omitted, but an operation of the control point 140 can be analogized from an operation of the control point 120.

Under the condition that the DHCP server 150 is connected to the network, the UPnP communication devices 110 to 140 conduct communications by use of the IP addresses allocated by the DHCP server 150. Afterwards, the UPnP communication devices 110 to 140 regularly check the presence of the DHCP server 150. If the DHCP server 150 is disconnected from the network, the UPnP communication devices 110 to 140 having sensed this disconnection will select new IP addresses by use of the Auto IP allocating function.

If the controlled device 110 first senses the non-presence of the DHCP server 150 (S110), the controlled device 110 newly establishes its own IP address by use of the Auto IP allocating function (S115). The non-presence of the DHCP server 150 means that the DHCP server 150 is disconnected from the network. At this time, the controlled device 110 may perform an operation to ascertain whether any other UPnP communication devices within the network use the new IP address selected for its own use, as in the conventional art.

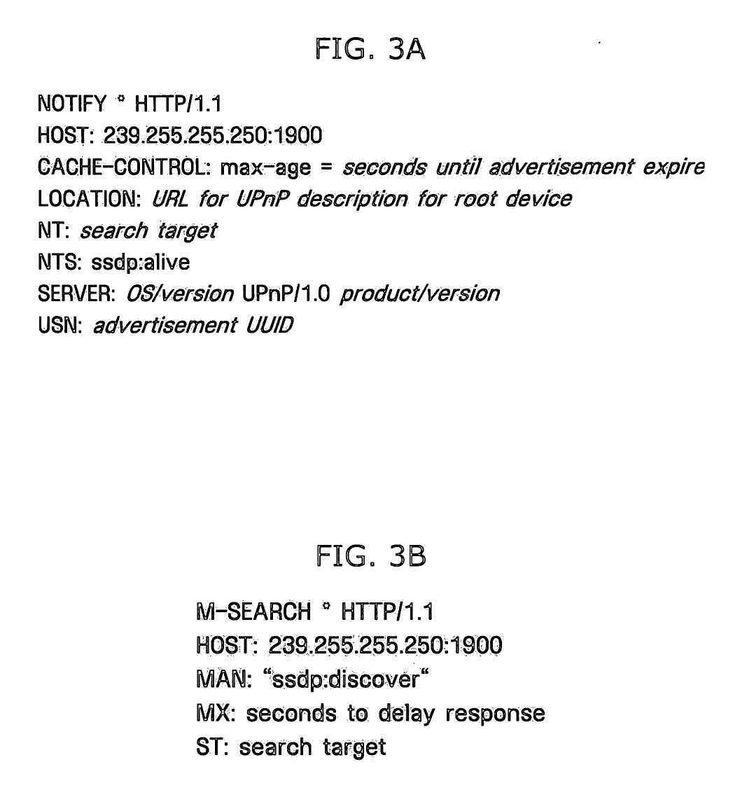

The controlled device 110 having set up a new IP address for their own use can notify the control points 120 and 140 by use of the changed IP address that its IP address has been changed (S120). This notification may be conducted through an Advertisement packet defined in the UPnP, and a construction of the Advertisement packet according to an exemplary embodiment of the present invention is illustrated in FIG. 3A. The Advertisement packet can be multicast.

The control point 120 having received the Advertisement packet determines whether the source IP of the received packet has the same subnet address as its own (S125). That is, the control point 120 may determine whether the source IP address of the Advertisement packet is out of the address range set up by the Auto IP allocating function.

If the source IP address has a different subnet address from its own, the control point 120 may ascertain whether the DHCP server 150 is present, regardless of the checking period to check for a change in the presence of the DHCP server 150 (S130).

As a result, if it is ascertained that the DHCP server 150 is not present, the control point 120 sets up a new IP address through the Auto IP allocating function (S135). This operation is also performed by the control point 140. According to this, all of the control points present in the network can set up new IP addresses for their own use through the Auto IP allocating function.

The control point 120, which will use the new IP address, notifies the controlled device 130 that its own IP address has been changed (S140). This notification may be conducted by a Search packet defined in the UPnP, and a construction of the Search packet according to an exemplary embodiment of the present invention is illustrated in FIG. 3B. The Search packet can be multicast.

The controlled device 130 determines whether the source IP address of the received packet has the same subnet address as its own address (S145). That is, the controlled device 130 can determine whether the source IP address of the Search packet is out of the address range set up by the Auto IP allocating function.

If the source IP address has a different subnet address from its own, the controlled device 130 may ascertain whether the DHCP server 150 is present, regardless of the checking period to check for a change in the presence of the DHCP server 150 (S150).

As a result, if it is ascertained that the DHCP server 150 is not present, the controlled device 130 sets up a new IP address through the Auto IP allocating function (S155). This operation is also performed by the other controlled devices (not shown) present in the network. According to this, all of the UPnP communications devices can set up new IP addresses for their own use through the Auto IP allocating function.

The controlled device 130, having set up a new IP address to be used through the Auto IP allocating function, may transmit a Response packet to the Search packet to the control point 120 by use of its own changed IP address.

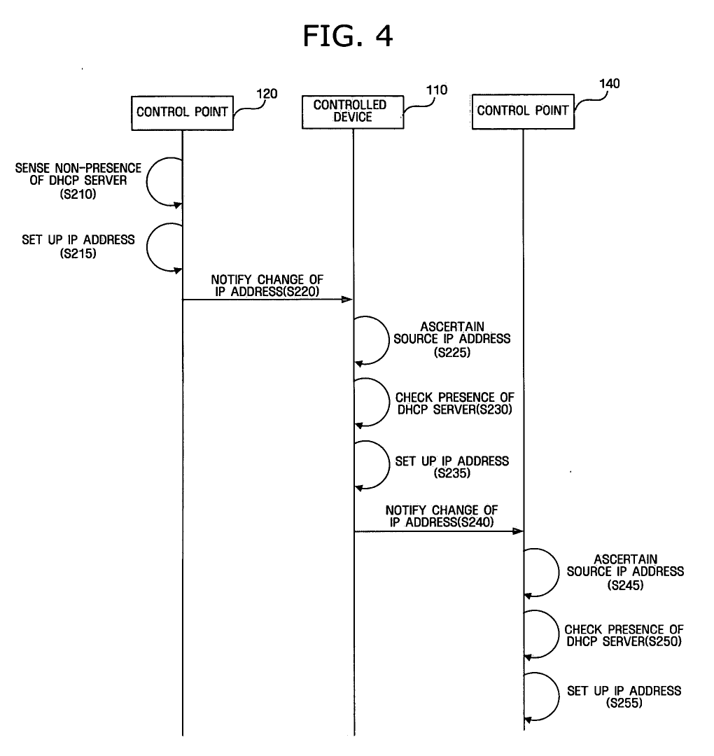

A second state in which a control point first senses that the DHCP server is disconnected from the network will be described with reference to FIG. 4.

In this exemplary embodiment, description of the controlled device 130 will be omitted, but an operation of the controlled device 130 can be analogized from an operation of the controlled device 110.

Under the condition that the DHCP server 150 is connected to the network, the UPnP communication devices 110 to 140 conduct communications by use of the IP addresses allocated by the DHCP server 150. Afterwards, the UPnP communication devices 110 to 140 regularly check the presence of the DHCP server 150. If the DHCP server is disconnected from the network, the UPnP communication devices 110 to 140 having sensed this disconnection will set up new IP addresses by use of the Auto IP allocating function.

If the control point 120 first senses the non-presence of the DHCP server 150 (S210), the control point 120 newly sets up its own IP address by use of the Auto IP allocating function (S215). The non-presence of the DHCP server 150 means that the DHCP server 150 is disconnected from the network. At this time, the control point 120 may perform an operation to ascertain whether any other UPnP devices within the network use the new IP address selected for their own use, as in the conventional art.

The control point 120 having set up a new IP address for its own use can notify the controlled devices 110 and 130 by use of the changed IP address that its own IP address has been changed (S220). As described above, this notification may be conducted through a Search packet.

The controlled device 110 having received the Search packet determines whether the source IP of the received packet has the same subnet address as its own address (S225). That is, the controlled device 110 may determine whether the source IP address of the Search packet is out of the address range set up by the Auto IP allocating function.

If the source IP address has a different subnet address from its own, the controlled device 110 may ascertain whether the DHCP server 150 is present, regardless of the checking period to check for a change in the presence of the DHCP server 150 (S230).

As a result, if it is ascertained that the DHCP server 150 is not present, the controlled device 110 sets up a new IP address through the Auto IP allocating function (S235). This operation is also performed by the controlled device 130. According to this, all of the controlled devices present in the network can set up new IP addresses for their own use through the Auto IP allocating function.

The controlled device 110 which will use the new IP address notifies the control point 140 that its own IP address has been changed (S240). This notification may be conducted by an Advertisement packet, as described above.

The control point 140 determines whether the source IP address of the received packet has the same subnet address as its own address (S245). That is, the control point 140 can determine whether the source IP address of the Advertisement packet is out of the address range set up by the Auto IP allocating function.

If the source IP address has a different subnet address from its own, the control point 140 may ascertain whether the DHCP server 150 is present, regardless of the checking period to check for a change in the presence of the DHCP server 150 (S250).

As a result, if it is ascertained that the DHCP server 150 is not present, the control point 140 sets up a new IP address through the Auto IP allocating function (S255). This operation is also performed by the other control points (not shown) present in the network. According to this, all of the UPnP communications devices can set up new IP addresses for their own use through the Auto IP allocating function.

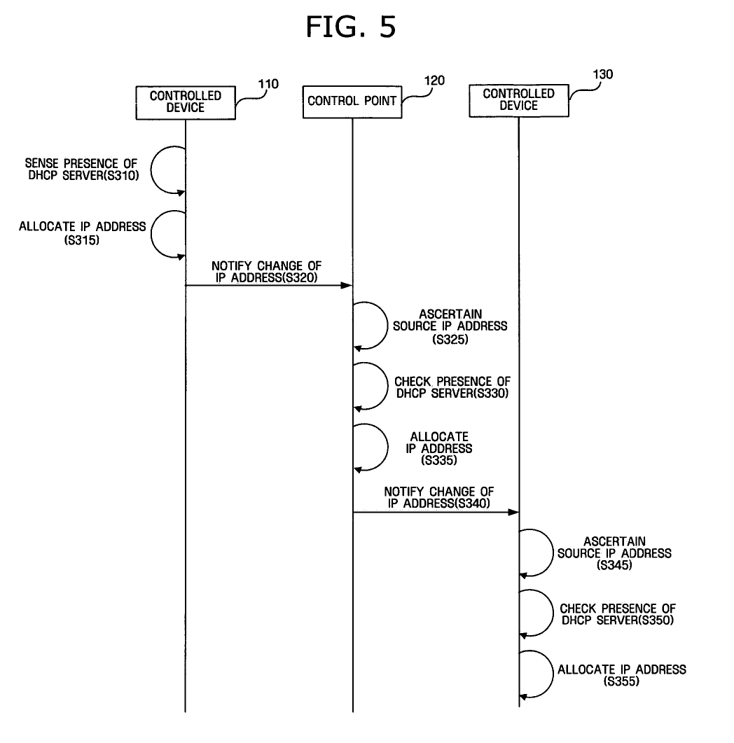

A third state in which a controlled device first senses that the DHCP server is connected to the network will be described with reference to FIG. 5.

In this exemplary embodiment, description of the control point 140 will be omitted, but an operation of the control point 140 can be analogized from an operation of the control point 120.

Under the condition that the DHCP server 150 is not connected to the network, the UPnP communication devices 110 to 140 conduct communications by use of the IP addresses set up through the Auto IP allocating function. Afterwards, the UPnP communication devices 110 to 140 regularly check the presence of the DHCP server 150. If the DHCP server is connected from the network, the UPnP communication devices 110 to 140 having sensed this connection requests the DHCP server 150 to allocate IP addresses to them, and uses the IP addresses allocated by the DHCP server 150.

If the controlled device 110 first senses the presence of the DHCP server 150 (S310), the controlled device 110 is allocated a new IP address by the DHCP server 150 and uses it (S315). The presence of the DHCP server 150 means that the DHCP server 150 is connected from the network.

The controlled device 110 having been allocated a new IP address by the DHCP server 150 can notify the control points 120 and 140 by use of the changed IP address that its own IP address has been changed (S320). As described above, this notification may be conducted through an Advertisement packet.

The control point 120 having received the Advertisement packet determines whether the source IP of the received packet has the same subnet address as its own address (S325). That is, the control point 120 may determine whether the source IP address of the Advertisement packet is in the address range set up by the Auto IP allocating function.

If the source IP address has a different subnet address from its own, the control point 120 may ascertain whether the DHCP server 150 is present, regardless of the checking period to check for a change in the presence of the DHCP server 150 (S330).

As a result, if it is ascertained that the DHCP server 150 is present, the control point 120 may be allocated a new IP address by the DHCP server 150 (S335). This operation is also performed by the control point 140. According to this, all of the control points present in the network can be allocated new IP addresses by the DHCP server.

The control point 120 which will use the new IP address notifies the controlled device 130 that its own IP address has been changed (S340). As described above, this notification may be conducted by a Search packet.

The controlled device 130 having received the Search packet determines whether the source IP address of the received packet has the same subnet address as its own address (S345). That is, the controlled device 130 can determine whether the source IP address of the Search packet is in the address range set up by the Auto IP allocating function.

If the source IP address has a different subnet address from its own, the controlled device 130 may ascertain whether the DHCP server 150 is present, regardless of the checking period to check for a change in the presence of the DHCP server 150 (S350).

As a result, if it is ascertained that the DHCP server 150 is present, the controlled device 130 is allocated a new IP address for its own use by the DHCP server (S355). This operation is also performed by the other controlled devices (not shown) present in the network. According to this, all of the UPnP communications devices can be allocated new IP addresses by the DHCP server.

The controlled device 130 having been allocated a new IP address to be used may transmit a Response packet to the Search packet to the control point 120 by use of its own changed IP address.

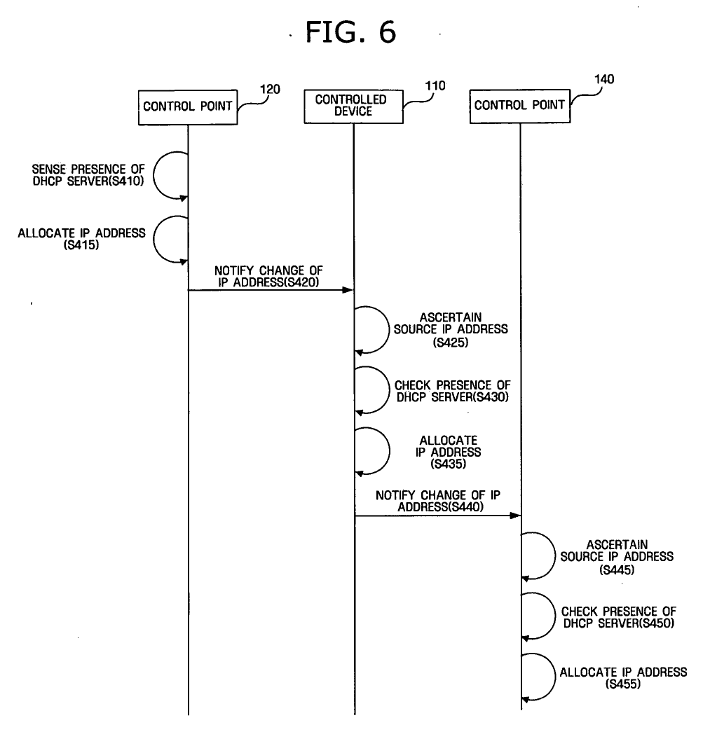

A fourth state in which a control point first senses that the DHCP server is connected to the network will be described with reference to FIG. 6.

In this exemplary embodiment, description of the controlled device 130 will be omitted, but an operation of the controlled device 130 can be analogized from an operation of the controlled device 110.

Under the condition that the DHCP server 150 is not present in the network, the UPnP communication devices 110 to 140 conduct communications by use of the IP addresses set up through the Auto IP allocation function. Afterwards, the UPnP communication devices 110 to 140 regularly check the presence of the DHCP server 150. If the DHCP server is connected from the network, the UPnP communication devices 110 to 140 having sensed this connection request the DHCP server 150 to allocate IP addresses to them, and accordingly, they are allocated new IP addresses by the DHCP server 150.

If the control point 120 first senses the presence of the DHCP server 150 (S410), the control point 120 requests the DHCP server 150 to allocate an IP address and receives an allocated new address (S415). The presence of the DHCP server 150 means that the DHCP server 150 is connected from the network.

The control point 120 having been allocated a new IP address for its own use can notify the controlled devices 110 and 130 by use of the changed IP address that its own IP address has been changed (S420). As described above, this notification may be conducted through a Search packet.

The controlled device 110 having received the Search packet determines whether the source IP of the received packet has the same subnet address as its own address (S425). That is, the controlled device 110 may determine whether the source IP address of the Search packet is in the address range set up by the Auto IP allocating function.

If the source IP address has a different subnet address from its own, the controlled device 110 may ascertain whether the DHCP server 150 is present, regardless of the checking period to check for a change in the presence of the DHCP server 150 (S430).

As a result, if it is ascertained that the DHCP server 150 is present, the controlled device 110 requests the DHCP server 150 to allocate an IP address, and receives an allocated new address (S435). This operation is also performed by the controlled device 130. According to this, all of the controlled devices present in the network can use new IP addresses allocated by the DHCP server 150.

The controlled device 110 having been allocated the new IP address notifies the control point 140 that its own IP address has been changed (S540). This notification may be conducted by an Advertisement packet, as described above.

The control point 140 having received the Advertisement packet determines whether the source IP address of the received packet has the same subnet address as its own address (S445). That is, the control point 140 can determine whether the source IP address of the Advertisement packet is in the address range set up by the Auto IP allocating function.

If the source IP address has a different subnet address from its own, the control point 140 may ascertain whether the DHCP server 150 is present, regardless of the checking period to check for a change in the presence of the DHCP server 150 (S450).

As a result, if it is ascertained that the DHCP server 150 is present, the control point 140 is allocated a new IP address by the DHCP server (S455). This operation is also performed by the other control points (not shown) present in the network. According to this, all of the UPnP communications devices can be allocated new IP addresses by the DHCP server 150.

As described above, when a UPnP communication device senses a change in the presence of the DHCP server over the network, it notifies the other UPnP communication devices of such a change. According to this, the UPnP communication devices can ascertain the presence of the DHCP server, regardless of the checking period to check for a change in the presence of the DHCP server 150. As a result, the interruption time of communications caused when an IP address is changed, because of a change in the presence of the DHCP server, can be reduced.

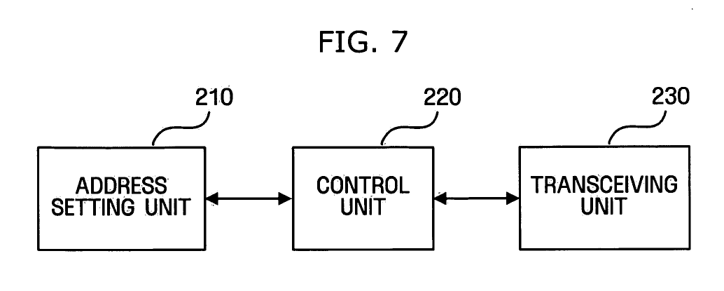

FIG. 7 is a block diagram illustrating a UPnP communication device according to an exemplary embodiment of the present invention.

As illustrated, the UPnP communication device comprises an address setting unit 210 which sets up an IP address, a control unit 220 which ascertains the presence of a DHCP server, and a transceiving unit 230 which is communicably connected to a wired or wireless medium, transmits data packets to other UPnP communication devices, and receives data packets from the other UPnP communication devices.

The address setting unit 210 set up an IP address to be used by the UPnP communication device. The set IP address may be an IP address allocated through the DHCP server, or an IP address allocated by performing an Auto IP allocating function.

The control unit 220 regularly checks whether the DHCP server is present in the network to which the UPnP communication device is connected. If a change occurs in the presence of the DHCP server, the control unit 220 controls the address setting unit 210 to thereby set up the IP address suitable for the changed environment.

For example, if it is sensed that the DHCP server present over the network is disconnected from the network, the control unit 220 controls the address setting unit 210 to thereby perform the Auto IP allocating function. If it is sensed that the DHCP server not present over the network is connected to the network, the control unit 220 controls the address setting unit 210 to thereby set up the IP address through the DHCP server. In this case, the address setting unit 210 may create a Request packet for IP allocation, to be sent to the DHCP server, and as a result, set up an IP address allocated by the DHCP server, as the IP address to be used by the UPnP communication device.

If the address setting unit 210 sets up a new IP address because a change has occurred in the presence of the DHCP server, the control unit 220 creates a data packet with which the changed IP address can be sent to the other UPnP communication devices, and sends it through the transceiving unit 230. The data packet may be an Advertisement packet or a Search packet as described above. The type of packets is determined depending upon whether the UPnP communication device is a control point or a controlled device.

When a predetermined data packet (e.g., an Advertisement packet or a Search packet) is received from the other UPnP communication device, the control unit 220 determines whether the source IP address of the received packet is within the same subnet as the IP address set up on the IP setting unit 210. If the source IP address of the received packet belongs to the different subnet from the IP address set up on the address setting unit 210, the control unit 220 ascertains the presence of the DHCP server, regardless of the checking period to check for a change in the presence of the DHCP server. As a result, if a change has occurred in the presence of the DHCP server, the control unit 220 controls the address setting unit 210 to set up an IP address appropriate for the changed environment.

Operations of the UPnP device may be understood from the detailed description of FIGS. 2 through 6.

As described above, the UPnP communication method and device of the present invention are effective in reducing the interruption time of communications due to a change in IP addresses by allowing UPnP communication devices having sensed a change in the presence of a DHCP server over the network to change the IP addresses appropriate for the changed environment.

It will be understood by those of ordinary skill in the art that various replacements, modifications and changes in form and details may be made therein without departing from the spirit and scope of the present invention as defined by the following claims. Therefore, it is to be appreciated that the above described exemplary embodiments are for purposes of illustration only and are not to be construed as limiting the invention.

What is claimed is:

1. A method for universal plug and play communications, which is performed by a communication device, the method comprising:
checking for a change in a presence of a dynamic host configuration protocol (DHCP) server in a network to which the communication device belongs;
changing an Internet protocol address used by the communication device to a new Internet protocol address allocated appropriately for a changed environment if it is determined as a result of the checking that the change has occurred in the presence of the DHCP server; and
notifying another communication device of the new Internet protocol address.

2. The method of claim 1, wherein the checking for the change in the presence of the DHCP server is performed periodically.

3. The method claim 1, wherein the checking for the change in the presence of the DHCP server is performed if a source address included in a predetermined packet sent from the other communication device does not belong to a same subnet as the Internet protocol address used by the communication device.

4. The method of claim 1, wherein the new Internet protocol address is allocated by the DHCP server or by performing an auto Internet protocol address allocating function.

5. A device for universal plug and play communications, the device comprising:
a transceiving unit transmits data to and receives data from another communication device;
an address setting unit which changes an Internet protocol address used by the device to a new Internet protocol address allocated appropriately for a changed environment if it determined that a change has occurred in a presence of a dynamic host configuration protocol (DHCP) server in a network connected to the device through the transceiving unit; and
a control unit which checks for the presence of the DHCP server, and transmits the new Internet protocol address to the other communication device through the transceiving unit.

6. The device of claim 5, wherein the control unit periodically checks for the presence of the DHCP server.

7. The device of claim 5, wherein the control unit checks for the presence of the DHCP server if a source address included in a predetermined packet sent from the other communication device does not belong to a same subnet as the Internet protocol address used by the device.
